(19) United States
(12) Patent Application Publication
(10) Pub. No.: US 2017/0053520 A1
(43) Pub. Date: Feb. 23, 2017

(54) ALARM UNIT

(71) Applicant: Cook Foundation Holdings Ltd., Rarotonga, Cook Islands (NZ)

(72) Inventors: Jonathan COOK, Faversham Kent (GB); Michael COOK, Chatham Kent (GB)

(21) Appl. No.: 15/307,791

(22) PCT Filed: Apr. 30, 2015
(86) PCT No.: PCT/GB2015/051266

§ 371 Date: Oct. 28, 2016

(30) Foreign Application Priority Data
Apr. 29, 2014 (GB) 1407526.1

(51) Int. Cl. G08B 25/00; G08B 25/10

(52) U.S. Cl. CPC G08B 25/008; G08B 25/10

(57) ABSTRACT

A self-contained alarm unit for use in a network comprising a plurality of similar self-contained alarm units together with at least one sensor unit for sensing an alarm event and a remote control unit, the alarm unit comprising an enclosure in which is provided an alert generator for generating an audible or visual alert, a power supply, a receiver for receiving an alarm signal from the sensor unit, an alert signal from another alarm unit, and a disarm signal from another alarm unit or the remote control unit, a transmitter for transmitting an alert signal to another self-contained alarm unit, or the remote control unit and a disarm signal to another self-contained alarm unit; and a control module comprising a processor, wherein the processor is adapted to execute instructions so as to: control the alert generator so as to generate a continuous or repeating alert in response to the alarm signal or the alert signal being received by the receiver, control the alert generator to stop generating the continuous or repeating alert in response to the disarm signal being received by the receiver, control the transmitter to transmit the alert signal in response to the alarm signal being received by the receiver; and control the transmitter to transmit the disarm signal in response to the disarm signal being received by the receiver.

### FIELD OF INVENTION

The present invention relates to an alarm unit, in particular a self-contained alarm unit.

### BACKGROUND TO THE INVENTION

Alarm units are used to protect property, objects and people. Conventional alarm units can be used to detect a number of events, including an intruder in a property, smoke or heat in the event of fire or to monitor a person's health. Typically, an alarm unit will comprise at least one sensor for detecting a particular event, such as an intrusion or a fire, a control panel located in the alarm unit or elsewhere on the property that registers when the sensor has detected the event, and an alarm generating component, which is activated by the control panel.

Conventional property alarm units will usually comprise a number of sensors to detect whether a door or window has been opened and/or a number of motion detectors to detect movement, a control panel and a siren and/or light for alerting a person to an intrusion. The sensors will be installed at various positions around the property and connected to the control panel, which is typically connected to a mains power supply. In recent years, these alarms are commonly linked to call centres that may contact a local police centre in the event of the alarm being activated. This will typically require the alarm system to be connected to a main telephone line. Alarm units of this type are commonly employed in properties and commercial buildings. Once the alarm has been triggered, an authorised person will disarm the alarm unit using the control panel.

With the number of vacant properties rising and housing becoming increasingly expensive, landlords of vacant properties or commercial properties are having to deal with issues such as people squatting in their properties. This often results in damage to the property, clean-up costs, costs associated with not being able to use the property and legal fees resulting from eviction proceedings. This is a particular problem for landlords of commercial properties, who have to instigate court proceedings before squatters can legally be removed. Conventional alarm systems do not provide sufficient protection for landlords to prevent this type of intrusion.

### SUMMARY OF THE INVENTION

According to a first aspect of the invention, there is provided a self-contained alarm unit for use in a network comprising a plurality of the self-contained alarm units together with at least one sensor unit for sensing an alarm event and a remote control unit, the alarm unit comprising an enclosure in which is provided an alert generator for generating an audible or visual alert, a power supply, a receiver for receiving an alarm signal from the sensor unit, an alert signal from another alarm unit, and a disarm signal from another alarm unit or the remote control unit, a transmitter for transmitting an alert signal to another self-contained alarm unit, or the remote control unit and a disarm signal to another self-contained alarm unit; and a control module comprising a processor, wherein the processor is adapted to execute instructions so as to: control the alert generator so as to generate a continuous or repeating alert in response to the alarm signal or the alert signal being received by the receiver, control the alert generator to stop generating the continuous or repeating alert in response to the disarm signal being received by the receiver, control the transmitter to transmit the alert signal in response to the alarm signal being received by the receiver; and control the transmitter to transmit the disarm signal in response to the disarm signal being received by the receiver.

Embodiments may therefore provide a self-contained alarm unit capable of detecting the occurrence of an event via a detector or sensor and alerting persons in the proximity of the alarm unit and notifying a remote control unit that a particular event has been detected via a detector or sensor. The alarm unit may form part of a linked alarm system comprising other self-contained alarm units, detectors or sensors and at least one remote control for remotely controlling the self-contained alarm unit, in other words a control panel or unit that is located remote from the alarm unit. Each of the alarm units of the alarm system may have means for generating audible or visual alarms to alert persons proximal to each of the alarm units that an event has been detected and may be capable of informing the remote control unit that an event has been detected. Each of the self-contained alarm units may be enclosed in an enclosure or housing such that they may be protected from damage and interference. Thus, embodiments of the alarm unit may therefore provide an alarm unit that cannot easily be modified, disarmed or silenced without using the remote control and a system comprising a number of independent alarm units, each providing an alert, which cannot be modified, disarmed or silenced without using the remote control or significant force. Furthermore, the enclosures may allow the alarms to withstand harsher conditions, such as rain, wind, damp, cold temperatures, etc. and therefore can be installed in properties that are not fully enclosed, or are not water-tight, for instance or the alarm units may be installed at least partially outside, for example under a porch or on an external wall.

The alarm unit is thus an independent unit having a power supply, an enclosure and the electronic systems capable of receiving, transmitting and processing data. By having its own power supply, the alarm unit does not need to be connected to a mains power supply. This is particularly important in vacant properties where a power supply may not be available and it also prevents the alarm system being disabled through disconnecting the power to the alarm, or disconnecting the power to the property the alarm is protecting.

The electronic components of the alarm unit may allow the alarm to be linked in a chain-like fashion to the other alarm units. In this respect, the triggering or arming of an alarm unit in response to the detection of an event may result in the triggering of all of the alarm units in the network, even if some of the alarm units are out of range or not connected to the sensor that has been activated. This is because the alarm units may act as a chain, with each alarm system transmitting an alert signal to other alarm units and thus all alarm units that are connected in the network will be emitting an audible or visual alert. This has the additional advantage that each alarm unit must therefore be disabled to disable the alarm system and to disable or disarm the audible and/or visual alerts. Thus, if an unauthorised person is trying to disable the alarm units of the alarm system, for example an intruder, it is significantly more difficult than a conventional property alarm as all must separately be disabled. Moreover, since the alarms are housed in an enclosure, with the audible or visual alert generators being housed in the enclosure with a power supply, each alarm unit in the network must be individually disabled with sufficient force to destroy or damage the enclosures to turn off the audible or visual alerts. This may result in criminal damage, which can be an important step to prove in the process of evicting squatters, for example. The difficulty of disabling the systems can also be increased by the placement of the alarms in a property, for example by placing the alarm units in hard-to-reach places such as on a rafter or above head height.

The control module of the alarm system may be any processing device known in the art capable of controlling the transmitter, receiver and alert generator. For example, it may be a computing device having a processing unit, a main memory. In some embodiments, the transmitter, receiver and control module may be incorporated into a single unit.

The triggering of an alarm unit may also cause the alarm unit to transmit an alert signal to a remote control unit. Thus, even if all the alarm units are disabled after an alert has been triggered, the event may still have been notified to the remote control unit. The remote control unit may also be used to disable all the audible or visual alert of the alarm units in the system or network by transmitting a disarm signal to one of the alarm units. The disarmed alarm unit may then subsequently transmit a disarm signal to other alarm units in the network. Thus, while the alarm units are independent and thus difficult to disable or disarmed using force, they may all be disarmed using a single remote control. Alternatively or in addition, the remote control may send a disarm signal to multiple alarm units in the network.

By continuous or repeating it is meant that the audible or visual alert that is generated by the alert generator is either an alert that remains active (e.g. outputting a sound or display or light, etc.) for the entire duration from when the alarm is activated (e.g. receives an alarm or alert signal) to when it is disabled, for example if the alert generator is an audible alert generator then a single (or varied) tone is output continuously, or that an alert sequence may have a limited duration, which is repeated at set intervals.

In an embodiment, the alarm unit further comprises a self-contained power generation means. This may enable the alarm unit to replenish the internal power supply without requiring maintenance or connecting to a mains power supply. Accordingly, the alarm unit may be able to power itself for a significant period of time, without being attached to a mains power system. Self-contained power generation means may include, for example, include a solar panel or a wind turbine.

In a further embodiment, the receiver is further for receiving a status query signal from the remote control unit and the control module is further adapted to control the transmitter so as to transmit a status signal to the remote control unit in response to the receiver receiving a status query signal from the remote control unit. In this embodiment, the remote control unit is able to obtain status information relating to an alarm unit remotely. Thus, the remote control unit may be used to monitor the condition of an alarm unit, an alarm system and/or multiple alarm systems. Status information may, for example, include information such as remaining battery life, the number of connected alarm units, the number of connected sensors or current configurations, such as the audible or visual alert settings.

In a further embodiment, the receiver is further for receiving a status query signal from other self-contained alarm units and the control unit is further adapted to control the transmitter so as to transmit a status query signal to the other self-contained alarm units in response to the receiver receiving a status query signal from the remote control unit and control the transmitter as to transmit a status signal to the one of the other self-contained alarm units in response to the receiver receiving a status query signal from the one of the other self-contained alarm units. In this embodiment, the remote control unit may send a status query to a single alarm unit, for example if the remote control unit is only connected to one alarm unit, or if only one alarm unit has the required equipment to connect to a remote control unit. The alarm unit receiving the status query signal can then relay the signal to other alarm units in the system. The alarm unit may then relay the status signal containing the information from another alarm unit back to the remote control unit.

In a further embodiment, the remote control unit is a handheld device, a device adapted for fixed installation or a server located at a location remote from the alarm unit. The remote control unit may therefore be a device that a user can take with them, such as a smartphone or a pager, which means that a person may receive updates regardless of their location and the person may be able to determine the status of the alarms remotely. Alternatively, the remote control unit may be a server such as a laptop or personal computer located on a site remote from the alarm unit, for example a central control centre. In another embodiment, the remote control unit may be fixedly installed, for example on site where the alarm units are located, or remotely, such as in a central control centre.

In further embodiments, the alarm signal and/or the alert signal comprises information encoding the type or identity of the sensor unit and/or the nature of the alarm event. In another embodiment, the nature of the alert generated by the alert generator is dependent on the information encoded in the alarm signal or the alert signal received by the receiver. By encoding the signal with information regarding the sensor, the alert that is generated by the alarm unit may be altered depending on the nature of the alarm event. Additionally, it will serve as useful information for the user as it will allow them to take action that is appropriate for the type of signal.

In another embodiment, the control module is further adapted to monitor an amount of energy remaining in the power supply and to control the transmitter so as to transmit a power level notification to the remote control unit. This ensures that if the power supply in the alarm unit is depleted, or nearly depleted, the alarm unit may alert the remote control unit that action needs to be taken or provide an audible or visual alert, which may be different to that generated upon detecting an event. It also may indicate a fault if, for instance, the power supply is failing.

In another embodiment, the alert generator is adapted to generate a variable high frequency audible tone, in particular having a frequency in the region of 7 to 19 KHz. At the frequency, the audible tone may be particularly uncomfortable for people in the vicinity of the alarm. Thus, it may be used to deter intruders and to discourage people from remaining in the vicinity of the alarm unit (and therefore the property).

In another embodiment, the sensor unit can be a smoke detector unit, a heat detector unit, a flood detector unit or a proximity detector unit.

In another embodiment, the transmitter is a wireless transmitter and the receiver is a wireless receiver. In this embodiment, the alarm units may be wirelessly connected so as to increase the self-contained nature of the alarms as the connections between the two, and thus any vulnerability in the network caused by the connections between the alarm units, may be decreased. Furthermore, the alarm units may be located in areas in which it would be difficult to connect wires and therefore installation is simplified.

In another embodiment, the alarm unit is a property alarm unit.

According to a second aspect of the invention, there is provided a network comprising a self-contained alarm unit comprising an enclosure in which is provided an alert generator for generating an audible or visual alert, a power supply, a receiver for receiving an alarm signal from the sensor unit, an alert signal from another alarm unit, and a disarm signal from another alarm unit or the remote control unit, a transmitter for transmitting an alert signal to another self-contained alarm unit, or the remote control unit and a disarm signal to another self-contained alarm unit; and a control module comprising a processor adapted to execute instructions so as to control the alert generator so as to generate a continuous or repeating alert in response to the alarm signal or the alert signal being received by the receiver, control the alert generator to stop generating the continuous or repeating alert in response to the disarm signal being received by the receiver, control the transmitter to transmit the alert signal in response to the alarm signal being received by the receiver; and control the transmitter to transmit the disarm signal in response to the disarm signal being received by the receiver; a sensor unit for sensing an alarm event; and a remote control unit.

Embodiments may therefore provide a system in which a linked system of an alarm unit, a remote control unit and a sensor is provided.

In an embodiment, the network comprises at least two self-contained alarm units.

### BRIEF DESCRIPTION OF THE DRAWINGS

An example of the invention will now be described with reference to the accompanying diagrams, in which:

FIG. 1 shows an embodiment of the invention;

FIG. 2 shows a pictorial representation of an example system in which aspects of the illustrative embodiments may be implemented;

FIG. 3 shows a schematic representation of an embodiment of the invention; and

FIG. 4 shows a schematic representation of an embodiment of the invention.

### DETAILED DESCRIPTION

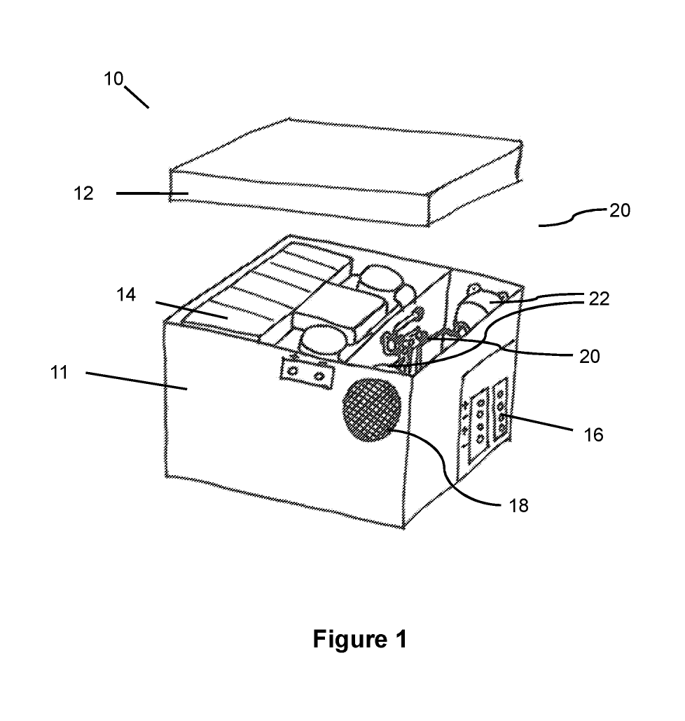

An embodiment of an alarm unit 10 in accordance with the present invention is shown in FIG. 1. The alarm unit 10 is housed within a steel enclosure comprising a steel body 11 and a steel lid 12. Within the housing is held a battery 14, electronic systems 20 and two speakers 22.

In use, the lid 12 of the alarm unit 10 will be sealed onto the body 11, for example using bolts or by welding. The lid 12 and the body 11 therefore form a steel enclosure 11, 12, which protects the alarm from damage and tampering. Preferably the lid 12 and the body 11 are connected such that they cannot easily be opened in situ so as to prevent tampering and damage but may be opened by an engineer or authorized person so as to facilitate maintenance. This may be achieved, for example, using tamperproof or security screw heads on bolts.

The electronic systems 20 of the alarm unit 10 include a transmitter, a receiver and a control module. In this embodiment, the transmitter refers to a unit that is capable of transmitting wirelessly. In particular, the transmitter of the embodiment of FIG. 1 is capable of transmitting signals wirelessly to other alarm units (not shown) and to the remote control unit (not shown). In this embodiment, the receiver is capable of receiving signals via a wireless network and via a wired connection. In particular, the receiver is capable of receiving wireless signals from other alarm units and a remote control unit and receiving signals via a wired connection from sensor units (not shown). In this embodiment, the wired connections of the sensor units connect to input terminals 16. In some embodiments, disconnection of the wired connection of a sensor unit from the alarm unit will result in the alarm being triggered and an alert signal being transmitted to other alarm units in the network and the remote control unit. The control module of the alarm system may be any processing device known in the art capable of controlling the transmitter, receiver and alert generator. For example, it may be a computing device having a processing unit and a main memory. In some embodiments, the transmitter, receiver and control module may be incorporated into a single unit.

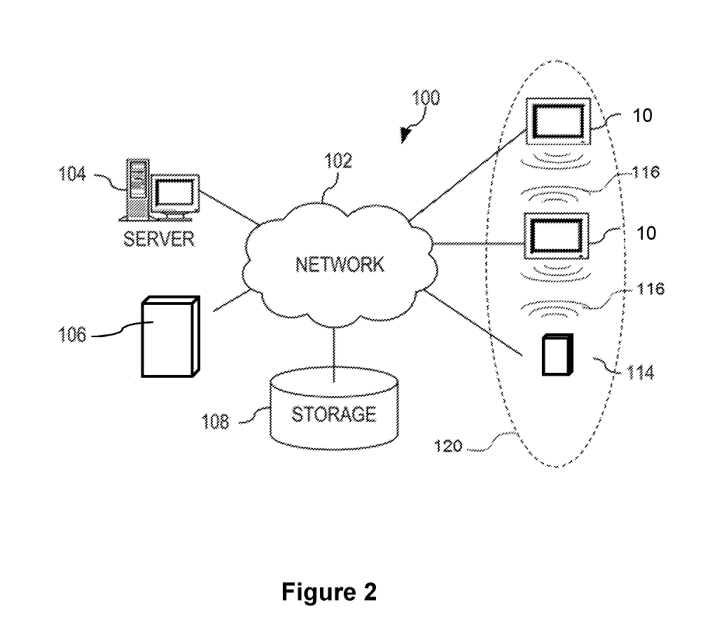

The alarm unit 10 may therefore be used in a network comprising a plurality of the self-contained alarm units together with at least one sensor unit for sensing an alarm event and a remote control unit. FIG. 2 depicts a pictorial representation of an example network in which aspects of the illustrative embodiments may be implemented.

Alarm network 100 may include a network of alarm units and other components in which aspects of the illustrative embodiments may be implemented. The system 100 contains at least one network 102, which is the medium used to provide communication links between various devices and alarm units 10 connected together within the system 100. The network 102 may include connections, such as wire, wireless communication links, or fiber optic cables.

In the depicted example, a server 104 is connected to the network 102 along with a storage unit 108. In addition, two alarm units 10, a sensor 114 and a hand-held device 106 are also connected to the network 102. Both server 104 and hand-held device 106 act as remote control units for controlling the alarm units 10 and for receiving notification of alarm events and storage unit 108 acts as a back-up for storing data and/or processor instructions, for instance.

The alarm units 10 and the sensor 114 may be provided with wireless communication capabilities so that they may communicate with each other via one or more short-range wireless communication links 116 separate from the network 102. For example, the alarm units 10 may be within short-range wireless communication network 120. Alternatively, they may be connected via wires. Similarly, the server 104 may be local to the alarm units 10 and thus may be connected via short-range wireless communication links (not shown) or via wired connection.

In the depicted example, the server 104 stores data, such as event information from the alarm units 10 and sensor 114. Alarm units 10 are clients to the server 104 in the depicted example and the server 104 may act as a remote control unit. The system 100 may include additional servers, alarm units, remote control units, sensors and other devices not shown.

In the depicted example, the system 100 is the Internet with the network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the system 100 may also be implemented to include a number of different types of networks, such as for example, a mobile phone/cell network, an intranet, a local area network (LAN), a wide area network (WAN), or the like. As stated above, FIG. 2 is intended as an example, not as an architectural limitation for different embodiments of the present invention, and therefore, the particular elements shown in FIG. 1 should not be considered limiting with regard to the environments in which the illustrative embodiments of the present invention may be implemented.

The two speakers 22 of the alarm unit 10 in this embodiment are activated to generate an audible alert by the control module. The tone, pitch and duration of the sounds generated by the speakers 22 may be controlled by the control module and may be programmable by the user. Thus, the control module can alter the output of the speakers 22 depending on the nature of the event detected by a sensor in the network and users may define the nature of the alert, depending on their specific requirements.

There are a number of ways in which the alarm unit 10 can be implemented including with any number of alarm units, sensors and remote control units (depending on network capacity).

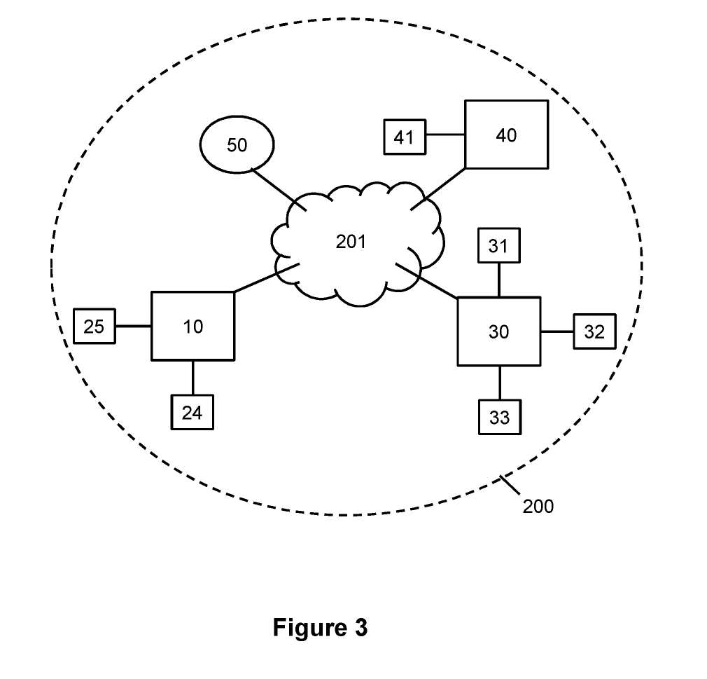

In one embodiment schematically depicted in FIG. 3, the alarm unit 10 may be deployed in a building with a number of additional alarm units 30 and 40 of the same design as the alarm unit 10 of FIG. 1 in an alarm system 200 (schematically depicted by the dashed line). In addition, there may be a number of sensors 24, 25, 31, 32, 33 and 41 associated with each of the alarm units 10, 30, and 40. In this embodiment, the sensors are connected via a wire (illustrated by the solid lines connecting the alarm units to the sensors) to the nearest alarm unit. For example, sensors 31, 32, 33 are wired to alarm unit 30. All three alarm units 10, 30, and 40 are connected via a long-range communications network 201. In this embodiment, the network is a cellular network to which all of the alarm units 10, 30, 40 are connected via their transmitters and receivers.

Accordingly, if a sensor detects an event, such as motion, fire, smoke or anything other desired event that can be detected by a sensor known in the art, the sensor sends an alarm signal to the alarm unit to which it is connected, via the wired connection. This will trigger/arm the alarm unit. For example, if sensor 41 was a heat detector and it detected heat above a particular threshold, it would relay an alarm signal to the alarm unit 40. The alarm signal indicates to the alarm unit 40 that the event has been detected, and it may also include information such as the nature of the event (for instance, if the sensor is a heat detector for detecting fire it may provide the exact temperature detected or, in other embodiments there may be continuous feedback indicating the length of exposure time to temperatures above a threshold). In another embodiment, it may be that the alarm unit 40 has been preprogrammed to understand that sensor 40 is a sensor of a particular type and therefore all that is required is an alarm signal indicating that an event has been detected.

Once the alarm signal has been received by the receiver of the alarm unit 40, the control module of the alarm unit 40 will activate the speakers of the alarm unit 40 to generate an audible alert. This will alert any nearby persons to the event and to take appropriate action. If the nearby users are hostile or not authorized to be in the area or on the property, for example an intruder, it may deter them from further unauthorized activities. The control module will also cause the transmitter of the alarm unit 40 to transmit an alert signal to the remote control unit 50 via the cellular network 201. In this embodiment, the remote control unit 50 is a handheld device located remote from the site of the alarm units 10, 30 and 40. This allows the owner of the property, or whoever is responsible for monitoring the alarm system 200, to be notified of the event irrespective of whether they are on site or not. The transmitter will also transmit an alert signal to other alarm units 10, 30 in the network 200, so as to alert them to the event. In this embodiment, the transmission of signals to the other alarm units 10, 30 in the network is automatically initiated by the control module of the alarm unit 40. The transmitter then sends the alert signal to the other alarm units. It does not require a response from the other alarm units 10, 30 and it does not continuously transmit an alert signal. This reduces the power used by the alarm units 40 when activated. Of course, the skilled person will appreciate that other methods of notifying the activation of an alarm may be employed. In another embodiment, the alarm unit may transmit a signal to the other alarm units 10, 30 in the network and continue transmitting a signal until a response (such as a confirmation signal) is received. Alternatively, it may just continue transmitting without listening for a response. This will ensure that all alarm units in the network are activated. The transmission may be a general broadcast or may be a targeted signal sent to each individual alarm unit.

Upon receiving the alert signal, the control modules of the other alarm units 10, 30 activate their speakers to produce an audible alert. In this embodiment, as the alarm units 10, 30 detect an alert signal (rather than an alarm signal) they may not proceed to broadcast a further alert signal, instead relying on the first alarm unit being in range of all of the other alarm units 10, 30. This can be configured on installation of the alarm unit, for example. This enables the other alarm units 10, 30 to conserve power by preventing unnecessary broadcasts.

With all of the alarm units 10, 30 and 40 activated, and the remote control unit notified of the detection of the event, the audible alerts may continue until the alarm unit 40 is disarmed (i.e. the audible alert is turned off). In some embodiments, the speaker may emit a loud alarm until a predetermined period has elapsed, then the audible alert may be reduced to an occasional tone until a disarm signal is received. In an alternative embodiment, the audible alert may continue for a predetermined period of time and then may be automatically disabled by the control module. In this case, the alarm may need to be reset from the armed configuration (i.e. having detected an event) to a ready state (i.e. waiting for an alert signal or an alarm signal). Thus, in some embodiments, disarming the alarm may therefore involve turning the audible or visual alert off, stopping the transmission of an alert signal (if continuous), causing the alarm unit to reset the sensor unit, if required, and/or reverting the alarm unit to a ready state, if required. In some embodiments, the alarm units may automatically revert to the ready state.

In an embodiment of the alarm system 200 of FIG. 3, the alarm system 200 may be used as an intrusion detection alarm, particularly adapted to deter squatters or damage to the property. In this embodiment, the sensors 24, 25, 31, 32, 33, 41 are therefore proximity or motion sensors and the alert generator comprises speakers adapted to generate a loud and repeating alert at a frequency that causes persons in the vicinity of the alarm discomfort. For example, the speakers transmit at any frequency between 2 kHz and 19 kHz. In one embodiment, the speakers may transmit at a frequency of between 2 kHz and 4 kHz and may vary between the frequencies during the alert. This frequency is found to be uncomfortable for people in the vicinity of the speakers and thus would act to deter people from remaining in the vicinity of the alarm. At higher frequencies, alerts may be activated at around 13 kHz, for example, at which point the sound is particularly uncomfortable for people of certain age grounds (e.g. young adults). However, it will be appreciated that the speakers may be configured to transmit at any frequency and/or may transmit at variable frequencies, depending on the preferences of the user, for example. Therefore, if a person enters the property while the alarm unit is installed and activated (i.e. in a ready state) and one of the sensors 24, 25, 31, 32, 33, 41 detects motion, for example, the alarm unit to which the activated sensor is connected will be triggered/armed and will generate an audible alert. The alarm unit will also send an alert signal to the alarm units in the system 200 and to the remote control unit 50. This will cause all of the alarm units 10, 30, 40 to be activated and thus generate the audible alert.

Given the nature of the audible alert in this embodiment (i.e. loud and at a frequency that causes discomfort to persons in proximity to the alarm) it acts a nuisance and causes discomfort to any nearby persons and thus dissuades a person from remaining in the vicinity of the alarm unit. This can therefore be used to reduce the time a person will want to remain in the property, which will reduce squatting and reduce the chances of damage being caused to the property. Moreover, since there are a number of independent and self-contained alarm units 10, 30, 40 emitting said audible alert, an intruder would have to locate and deactivate using force each of the alarm unit 10, 30, 40 to silence the alarm units. In the case of a squatter, any damage caused to the alarm units 10, 30, 40 may potentially provide basis for removal of the persons who caused the damage from the property, which would speed up the process of reclaiming the property. In any event, the alarm system 200 is significantly more difficult to deactivate than a conventional alarm system, since there is no mains power, it is enclosed in a steel case and each of the alarm units 10, 30, 40 has its own alert generating means. Moreover, due to the internal power supply and the ability to wirelessly connect the alarm units 10, 30, 40 to each other, installation of the alarm units 10, 30, 40 in places where there is no mains power, or wiring, is significantly easier. For example, the alarm units 10, 30, 40 may be installed on the rafters of a building or above a level at which a person could easily reach.

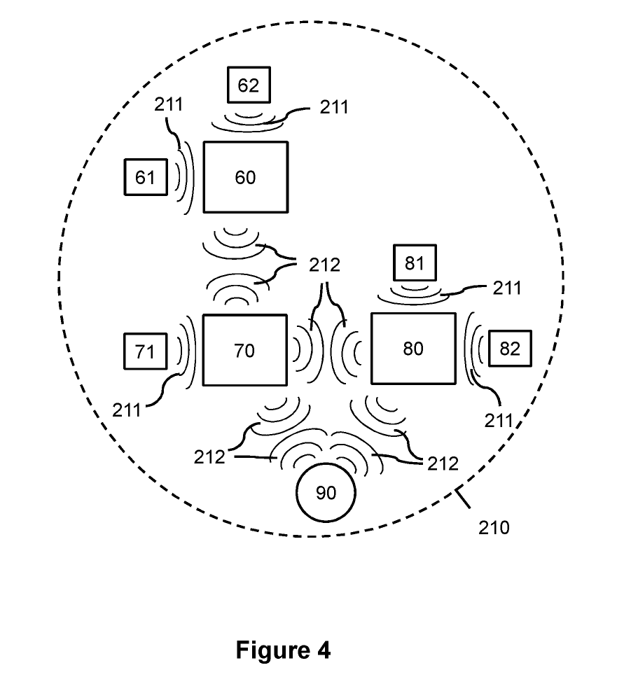

In another embodiment shown in FIG. 4, the alarm units 60, 70 and 80 are part of an alarm system or alarm network 210 (illustrated by the dashed line) that may be deployed in a property, for instance. The alarm units have the same construction as the alarm unit 10 of FIG. 1. In addition, there may be a number of sensors 61, 62, 71, 81 and 82 associated with each of the alarm units 60, 70, and 80. In this embodiment, the sensors are connected via a direct short-range wireless connection 211 to the nearest alarm unit. This may be, for example, via a Bluetooth or infrared connection. The alarm units 60, 70, and 80 utilise a mid-range wireless communications means 212 to communicate with other alarm units, such as a wireless LAN connection. However, in this embodiment, the alarm units 60 and 80 are spaced too far from one another to communicate directly and can both only communicate with alarm unit 70 via the wireless LAN connection 212. The same wireless communications means is used by the alarm units 70, 80 to communicate with the remote control unit 90. Due to the positioning of the remote control unit, which is fixed on the property containing the alarm units 60, 70, 80, only the alarm units 70 and 80 are in range of the remote control unit 90. In this embodiment, the remote control unit 90 is a control panel fixably mounted to a wall on the property being monitored by the alarm systems.

In this embodiment, the sensors 61, 62, 71, 81 and 82 are located about the property and are smoke detectors so as to detect if a fire breaks out in the property. If smoke is detected by sensor 71, which is connected to alarm unit 70, the alarm unit 70 responds in the manner described for the embodiment of FIG. 3—i.e. an alert signal is transmitted to the other alarm units 60, 80 and to the remote control unit 90 and an alert is generated by an alert generator. In this embodiment, the alert generator is a loud bell that rings continuously to inform nearby persons of a potential fire. Alternatively, if smoke is detected by sensor 61, the sequence is slightly modified, since alarm unit 60 is out of range of alarm unit 80 and remote control 90. In this case, the sensor 61 will send an alarm signal to the alarm unit 60, which will subsequently activate the bell and transmit an alert signal to the alarm unit 70. In this embodiment, the alarm unit 70, on receiving an alert signal form one of the other alarm units 60, 80 is configured to automatically broadcast or transmit an alert signal. Thus alarm unit 70 will transmit an alert signal to alarm unit 80 and to remote control 90, which have not yet been notified of the event. The reverse will occur when the alarm system is disarmed by the remote control. In this embodiment, it may be advantageous to have the remote control unit 90 located on the premises such that if an alarm unit is triggered, it can be deactivated by an authorized person on site, rather than having to locate the person in possession of the remote control unit off site. This may be achieved by entering a disarm code or by using a fob or swipe card system, for example.

The chaining or linking of alarms in this fashion allows for a versatile system in which a number of independent alarms are linked together to form a complete network, without requiring all of the alarm units to be in direct communication with one another. In some embodiments, only one of the alarm units may have the communication means capable of communicating with the remote control unit. For instance, only one alarm unit in the network may have a transmitter capable of communicating with a remote control unit across a cellular network. Similarly, only one alarm unit may be connected to a remote control unit with a wired connection. This may result in a “base station” alarm unit, which acts as a hub for communication with all of the other alarm units (which may additionally be connected to other alarm units in the system/network). This has the advantage that power consumption in the other alarm systems and the costs of the alarm units may be reduced, since long-distance communications components are not required. In some embodiments, the base station or an alarm unit may require confirmation that an alert signal has been received by an alarm signal before the base station or the alarm unit ceases transmission of the alarm signal. In further embodiments, there may be multiple base stations or hub-type alarm units in a single network.

In some embodiments, the base station unit(s) may also act as a gateway for the user to reprogram or control the alarm units. Thus, a user can use the remote control to reprogram the base station unit (or, indeed, any alarm unit it communication with the remote control unit) so as to change, for example, the duration of alarms, the type of alert emitted, the sensors that are enabled and the base unit (or alarm unit) may subsequently transmit these instructions to other alarm units in the network.

In another embodiment (not shown), the sensors may be in range of more than one alarm unit. In this case, the sensor may provide an alarm signal to more than one of the alarm units. It will also be appreciated that in other embodiments, the alarm systems may employ different types of sensors in the same alarm system to provide a multi-event protection system. For example, a system may incorporate means for detecting a fire (e.g. smoke or heat detectors), intrusion detectors (switches, motion detectors, IR detectors), or flood detectors.

The remote control unit may take a number of forms. For example, it may be may take the form of any of a number of different mobile computing devices including a tablet computer, a smart phone, a mobile phone, a laptop computer, a personal digital assistant (PDA), a smart watch, a wearable computing device (such as glasses or a wristband for example), or the like. It may also take the form of a control panel or a key fob or any other suitable means for receiving and transmitting the required signals and displaying an alert and optionally status information regarding the alarm units.

The power supply enclosed in the alarm unit may comprise any suitable power storage means known in the art. For instance, the power supply may be any type of battery capable of supplying such a system with sufficient power and for a suitable duration, for example at least 3 months, preferably at least 6 months, or more preferably at least 12 months. In some embodiments, the alarm unit may further comprise a power generation means. For example, the alarm unit may comprise a solar panel that provides power to the power supply. Alternatively, or in addition, the alarm unit may comprise a wind turbine either located within the enclosure (for example, behind a perforated entrance in the enclosure) or located at a location external to the enclosure but connected to the alarm unit. In some embodiments, the power supply will have sufficient storage capabilities such that if the power generation means is damaged or cannot generate suitable power, the alarm unit will still have power for a sufficient period of time such that the remote control unit can be notified and a replacement fitted (for instance, at least 1 day, preferably at least 1 week, more preferably at least 1 month). In an additional embodiment, the alarm unit may further comprise a proximity sensor located on an external power generation means so as to detect when a person approaches the power generation means. This will help to deter deliberate damage to the power generation means in an attempt to disable the alarm unit.

The audible and visual alert generators may be any suitable audible or visual alert generating means. For example, the audible alert generating means may be a speaker, a claxon, a bell, a horn, a whistle or any other form of sound generating means. The visual alert may be, for example, a screen or a light. In some embodiments, the alarm system may have a mesh or window that covers the visual alert generator such that the alert generating means is contained within the enclosure. In all embodiments, the alarm units are such that they can be upgraded and additional visual or audible alert generating means may be included.

In a further embodiment of an alarm system (not illustrated), an alarm unit may be deployed in a building as part of an alarm system comprising the alarm unit, a plurality of sensors and a remote control unit. In this embodiment, only the alarm unit, which has the same structure as the alarm unit 10 of FIG. 1, and the sensors are located on site. The remote control unit is a server located at a central location, where it can control and monitor multiple alarm systems located on different properties simultaneously. The alarm unit communicates with the remote control unit via a cellular network. In this embodiment, a lightweight and easy to install, centrally monitored alarm system can be provided.

Other variations to the disclosed embodiments can be understood and effected by those skilled in the art in practicing the claimed invention, from a study of the drawings, the disclosure, and the appended claims. For example, in the examples above:

an alarm system or network may comprise multiple remote control units in the single network and the remote control units may comprise numerous different types of remote control unit, for example it may comprise a handheld device and a server;

an alarm system or network may comprise multiple sensor units in the single network and the sensor units may be of different types such as heat detectors and intrusion detectors in the same network;

the sensor unit can be any suitable event detection means, for example a smoke detector unit, a heat detector unit, a flood detector unit or a proximity detector unit;

energy generation means may include any form of self-contained energy generator, for example, a wind-turbine or a solar panel;

the enclosure of housing of the alarm unit can be made of any suitable material for housing an alarm unit, including, for example any suitable metal such as steel, iron, aluminium, or a suitable plastic, for example, Polyurethanes, Polyesters, Polyethylene, Polystyrene, Polyvinyl Chloride, Polypropylene or any other suitable material known in the art.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A self-contained alarm unit for use in a network comprising a plurality of the self-contained alarm units together with at least one sensor unit for sensing an alarm event and a remote control unit, the alarm unit comprising an enclosure in which is provided:
an alert generator for generating an audible and/or visual alert;
a power supply;
a receiver for receiving an alarm signal from the sensor unit, an alert signal from another alarm unit, and a disarm signal from another alarm unit or the remote control unit;
a transmitter for transmitting an alert signal to another self-contained alarm unit, or the remote control unit and a disarm signal to another self-contained alarm unit; and
a control module comprising a processor adapted to execute instructions so as to:
control the alert generator so as to generate a continuous or repeating alert in response to the alarm signal or the alert signal being received by the receiver;
control the alert generator to stop generating the continuous or repeating alert in response to the disarm signal being received by the receiver;
control the transmitter to transmit the alert signal in response to the alarm signal being received by the receiver; and
control the transmitter to transmit the disarm signal in response to the disarm signal being received by the receiver.

2. The alarm unit of claim 1, further comprising a self-contained power generation means.

3. The alarm unit of claim 1, wherein:
the receiver is further for receiving a status query signal from the remote control unit; and
the control module is further adapted to control the transmitter so as to transmit a status signal to the remote control unit in response to the receiver receiving a status query signal from the remote control unit.

4. The alarm unit of claim 3, wherein:
the receiver is further for receiving a status query signal from other self-contained alarm units; and
the control unit is further adapted to:
control the transmitter so as to transmit a status query signal to the other self-contained alarm units in response to the receiver receiving a status query signal from the remote control unit; and
control the transmitter as to transmit a status signal to the one of the other self-contained alarm units in response to the receiver receiving a status query signal from the one of the other self-contained alarm units.

5. The alarm unit of claim 1, wherein the remote control unit is a handheld device, a device adapted for fixed installation or a server located at a location remote from the alarm unit.

6. The alarm unit of claim 1, wherein the alarm signal comprises information encoding type or identity of the sensor unit and/or the nature of the alarm event.

7. The alarm unit of claim 1, wherein the alert signal comprises information encoding type or identity of the sensor unit and/or the nature of the alarm event.

8. (canceled)

9. The alarm unit of claim 1, wherein the control module is further adapted to monitor an amount of energy remaining in the power supply and to control the transmitter so as to transmit a power level notification to the remote control unit.

10. The alarm unit of claim 1, wherein the alert generator is adapted to generate a variable high frequency audible tone, in particular having a frequency in the region of 7 to 19 KHz.

11. The alarm unit of claim 10, wherein the sensor unit can be a smoke detector unit, a heat detector unit, a flood detector unit or a proximity detector unit.

12. The alarm unit of claim 1, wherein the transmitter is a wireless transmitter and the receiver is a wireless receiver.

13. A network comprising:
a self-contained alarm unit according to claim 1;
a sensor unit for sensing an alarm event; and
a remote control unit.

14. The network of claim 13, further comprising at least a second one of said self-contained alarm units according to.

15. The alarm unit of claim 6, wherein the nature of the alert generated by the alert generator is dependent on the information encoded in the alarm signal or the alert signal received by the receiver.

16. The alarm unit of claim 7, wherein the nature of the alert generated by the alert generator is dependent on the information encoded in the alarm signal or the alert signal received by the receiver.
